(19) United States
(12) Patent Application Publication
(10) Pub. No.: US 2026/0149515 A1
(43) Pub. Date: May 28, 2026

(54) INFORMATION DISTRIBUTION APPARATUS, PREDICTION SYSTEM, INFORMATION DISTRIBUTION METHOD, AND PROGRAM

(71) Applicant: NTT, Inc., Tokyo (JP)

(72) Inventors: Naoki SHIBUYA, Tokyo (JP); Kenichi KAWAMURA, Tokyo (JP); Motoharu SASAKI, Tokyo (JP); Takatsune MORIYAMA, Tokyo (JP)

(21) Appl. No.: 19/114,575

(22) PCT Filed: Oct. 26, 2022
(86) PCT No.: PCT/JP2022/039992

§ 371 Date: Mar. 24, 2025

(51) Int. Cl. H04B 17/391

(52) U.S. Cl. CPC H04B 17/3912

(57) ABSTRACT

An information distribution device includes a generation unit that generates a model for predicting communication quality in a terminal, and a distribution unit that distributes the model to the terminal.

### TECHNICAL FIELD

The present invention relates to a technology for predicting wireless communication quality.

### BACKGROUND ART

In applications such as remote control or remote monitoring of mobile objects such as vehicles and robots, remote communication is generally performed by wireless communication between a server at a center and terminals installed in on-site mobile objects. In addition, since mobile objects are mobile, high availability is required for the quality of wireless remote communications, taking safety into consideration. It is considered to be effective to estimate (predict) whether wireless communication quality will be stable at a mobile object's moving destination, and in a case where there is a risk, to take measures such as switching a line in advance or reducing a video transmission rate to prevent momentary interruptions in a video. Therefore, it is important to predict the communication quality at the moving destination.

As a technology for predicting wireless communication quality at destinations, for example, a technology disclosed in Non-Patent Literature 1 is known. In the technology disclosed in Non-Patent Literature 1, machine learning is used to train a model (which may be referred to as a learning device) that calculates a predicted value of wireless communication quality at the position of a terminal from past quality information.

By using this model, it is possible to predict the wireless communication quality at a future terminal position.

### CITATION LIST

### Non-Patent Literature

Non-Patent Literature 1: Naoki Shibuya et al., “A Study on Wireless Communication Quality Prediction Using Machine Learning,” IEICE General Conference, B-6-74, March 2022.

### SUMMARY OF INVENTION

### Technical Problem

In the related art, a terminal transmits an inquiry including a desired position or the like to a server equipped with a trained model, receives a predicted value of wireless communication quality from the server, and uses the predicted value to control NW switching or the like.

As described above, in the related art, the model exists on a server side. In this case, if communication between the terminal and the server is interrupted, the terminal becomes unable to receive a notification of the predicted value that is used for control.

The present invention has been made in view of the above points, and an object of the present invention to provide a technology that enables a terminal to calculate a predicted value without acquiring the predicted value from a server equipped with a model for predicting communication quality.

### Solution to Problem

According to the disclosed technology, there is provided an information distribution device including: a generation unit configured to generate a model for predicting communication quality in a terminal; and a distribution unit configured to distribute the model to the terminal.

### Advantageous Effects of Invention

According to the disclosed technology, a technology is provided that enables a terminal to calculate a predicted value without acquiring the predicted value from a server equipped with a model for predicting communication quality.

### BRIEF DESCRIPTION OF DRAWINGS

FIG. 1 is a diagram for describing a problem.

FIG. 2 is a diagram for describing an overview of an embodiment.

FIG. 3 is a diagram illustrating a configuration of a device according to a first example.

FIG. 4 is a flowchart for describing an operational example of the first example.

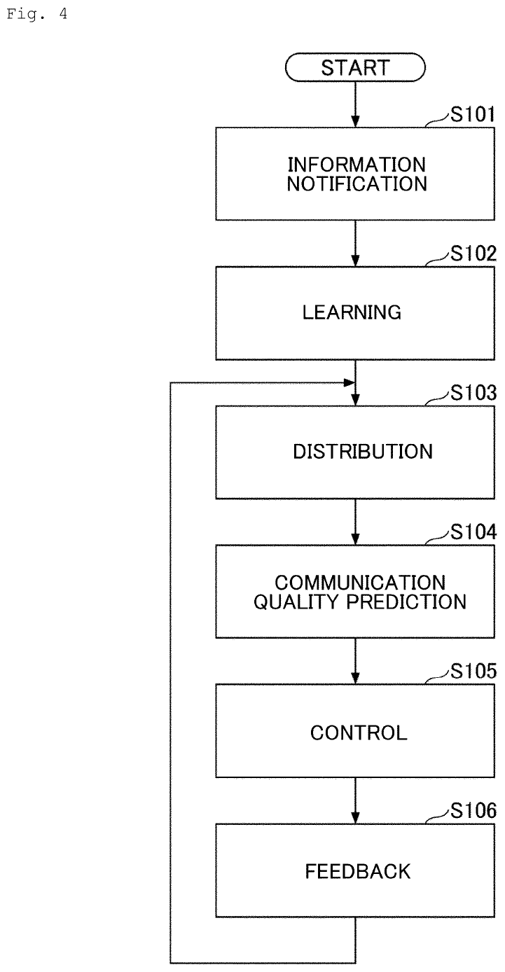

FIG. 5 is a diagram illustrating the configuration of the device according to a second example.

FIG. 6 is a flowchart for describing an operational example of the second example.

FIG. 7 is a diagram illustrating an example of a hardware configuration of the device.

### DESCRIPTION OF EMBODIMENTS

One or more embodiments of the present invention (present embodiment) will be described below with reference to the drawings. The embodiments to be described below are merely an example, and embodiments to which the present invention is applied are not limited to the embodiments to be described below.

In the following description, it is assumed that “communication quality” refers to quality in wireless communication, but the technology according to the present invention is also applicable to communication quality in wired communication rather than wireless communication. For example, the technology according to the present invention can be applied in an environment where devices that allow terminals to be connected to a network via wired connections are installed in various places (positions).

In the following description, unless otherwise specified, it is assumed that communication quality is the quality of communication when a terminal performs wireless communication. In addition, “communication quality” may be referred to as “quality”.

A “terminal” is assumed to be mobile. The “terminal” may be a smartphone or the like held by a person, or a communication device mounted on a mobile object such as a drone, an automobile, or a robot. The mobile object itself, such as a drone, an automobile, or a robot, may be referred to as the “terminal.”

Note that the “communication quality” used below may be any one of received power, throughput, delay, jitter, and packet loss, or the “communication quality” may be a quality other than these.

### Problem

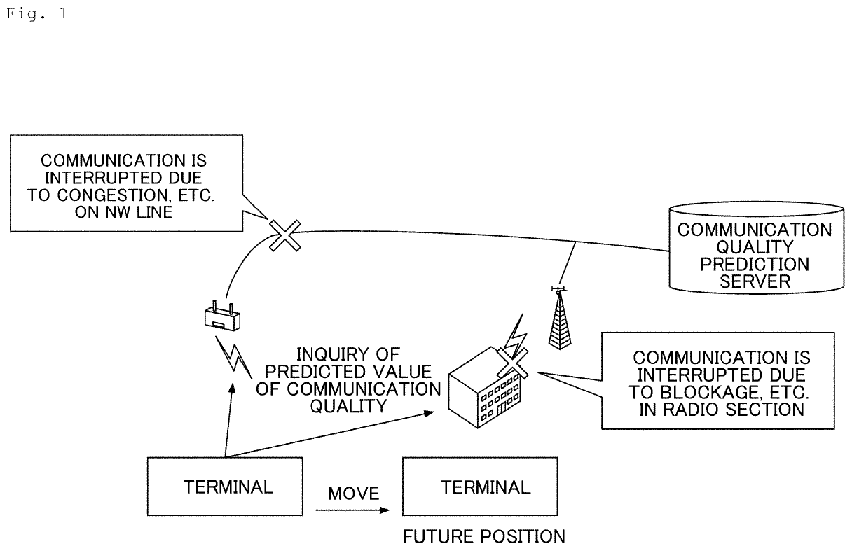

First, the problem in the present embodiment will be described with reference to FIG. 1. In a case where communication is normal, the terminal can transmit an inquiry including a future position or the like to a communication quality prediction server equipped with a trained model, and receive a predicted value of communication quality at that future position from the communication quality prediction server.

On the other hand, as illustrated in FIG. 1, in a case where communication is interrupted due to NW congestion, blockage, or the like in a radio section, the terminal cannot receive a notification of the predicted value from the wireless quality prediction server.

Hereinafter, the technology for calculating the predicted value by the terminal, without acquiring the predicted value from a server equipped with a model for predicting communication quality, will be described in detail.

### Example of Overall Configuration of System

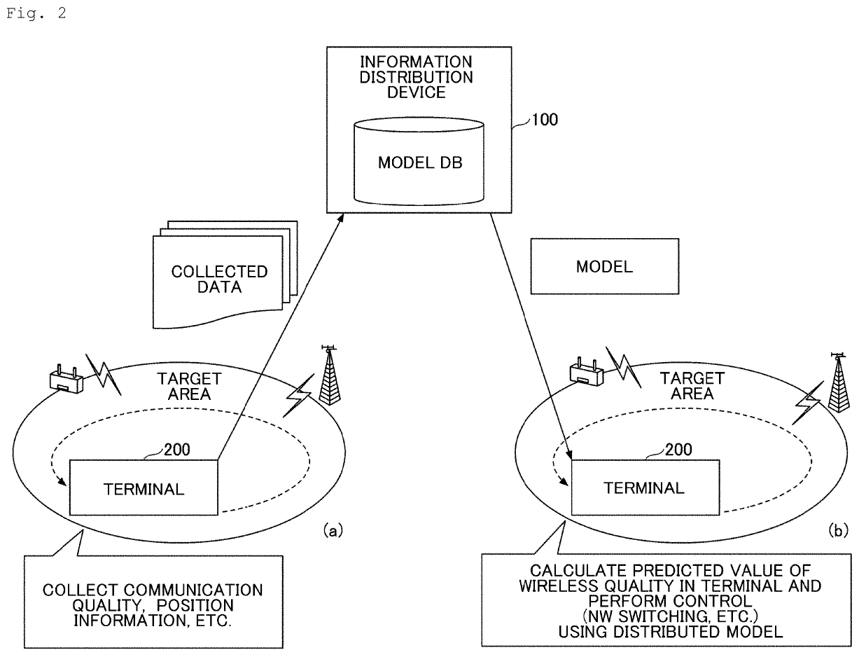

FIG. 2 illustrates an example of an overall configuration of a prediction system according to the present embodiment. The overview of the present embodiment will be described with reference to FIG. 2. As illustrated in FIG. 2, the prediction system includes an information distribution device 100 and a terminal 200. The information distribution device 100 and the terminal 200 can communicate with each other through a network including the radio section. Further, the information distribution device 100 may be a communication quality prediction server.

The terminal 200 moves in a target area where the prediction of communication quality is assumed to be performed. In the scene illustrated in (a), the terminal 200 transmits the communication quality (for example, throughput, received power, etc.) and position information of the position where the communication quality was measured as collected data to the information distribution device 100. The information distribution device 100 acquires communication quality measured at various points by a plurality of terminals.

The information distribution device 100 learns a model for predicting communication quality in a target area through machine learning, on the basis of data collected from the terminal 200. The trained model is stored in a model DB. This model is, for example, a neural network model, and in this case, the model DB stores one or more functions, weight parameters, and the like as the model.

Note that data used for machine learning is not limited to data collected from the terminal 200. Data collected from base stations (such as APs) may be used as data for machine learning.

In addition, the information distribution device 100 may perform propagation estimation in the target area, for example by a ray tracing method, by referring to a database (DB) that stores information on buildings, or the like, in the target area, and store propagation estimation results (for example, received power at each point, propagation loss at each point) in the model DB.

By using a propagation estimation result, a predicted value of communication quality at a desired point can be obtained. Therefore, the propagation estimation result is a type of model for predicting communication quality, and the propagation estimation result may be referred to as a “model.” In the scene illustrated in (b), the information distribution device 100 distributes (transmits) the model to the terminal 200. The terminal 200 uses the model received from the information distribution device 100 to calculate a predicted value of communication quality at a desired position (for example, a predicted future position). The predicted value is used for controlling line switching for example.

The above model may be a model based on machine learning, a model based on propagation estimation, or both the model based on machine learning and the model based on propagation estimation.

Moreover, the model may be distributed to a plurality of terminals simultaneously. In addition, the plurality of terminals may notify the information distribution device 100 of the collected data.

Hereinafter, a first example and a second example will be described as detailed examples of the device configuration and device operation.

### First Example: Configuration Example of Device

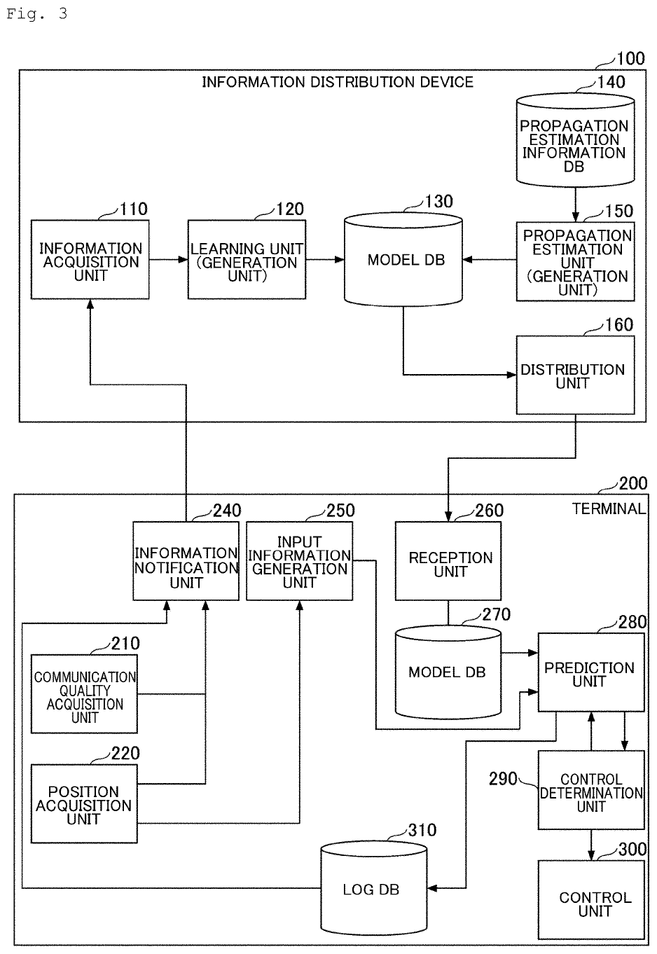

FIG. 3 illustrates a configuration example of the information distribution device 100 and the terminal 200 according to the first example. As illustrated in FIG. 3, the information distribution device 100 includes an information acquisition unit 110, a learning unit 120, a model DB 130, a distribution unit 160, a propagation estimation unit 150, and a propagation estimation information DB 140. Note that any one of “the information acquisition unit 110 and the learning unit 120” and “the propagation estimation unit 150 and the propagation estimation information DB 140” need not be provided. Additionally, both the learning unit 120 and the propagation estimation unit 150 may be referred to as a “generation unit”.

As illustrated in FIG. 3, the terminal 200 includes a communication quality acquisition unit 210, a position acquisition unit 220, an information notification unit 240, an input information generation unit 250, a reception unit 260, a model DB 270, a prediction unit 280, a control determination unit 290, a control unit 300, and a log DB 310.

The communication quality acquisition unit 210 is a functional unit that acquires communication quality (for example, throughput, received power, or the like) in the terminal 200. The position acquisition unit 220 is, for example, a GNSS receiver, and acquires the position information of the terminal 200. Furthermore, the terminal 200 may be equipped with various sensors. A notification of environmental state information (for example, information on temperature, humidity, surrounding objects and buildings, or the like) acquired by a sensor may be provided from the information notification unit 240 to the information distribution device 100.

### First Example: Operational Example

An operational example of each device having the configuration illustrated in FIG. 3 will be described with reference to the flowchart of FIG. 3.

### <S101>

The communication quality acquisition unit 210 in the terminal 200 acquires communication quality (for example, throughput, received power). The position acquisition unit 220 acquires position information of the terminal 200. In S101, the information notification unit 240 notifies the information distribution device 100 of data (information) including the acquired communication quality and position information as data for learning. This notification is performed periodically, for example.

The information acquisition unit 110 in the information distribution device 100 acquires the information provided by the terminal 200.

### <S102>

In S102, the learning unit 120 performs learning through machine learning using the information provided by the terminal 200. For example, a neural network model is trained that uses position information as an input and outputs (predicts) communication quality. The trained model is stored in the model DB 130. The data stored here as the trained model is, for example, a neural network function and weight parameters.

Furthermore, the propagation estimation unit 150 may perform propagation estimation for the target area using information stored in the propagation estimation information DB 140 and store the propagation estimation result in the model DB 130.

As described above, the propagation estimation result may be referred to as a “model”.

The propagation estimation information DB 140 stores information on buildings, base stations, and the like in the target area, and the propagation estimation unit 150 performs propagation estimation using, for example, a ray tracing method. The propagation estimation result is, for example, the received power at each position in the target area. When performing the propagation estimation, environmental state information received from the terminal 200 may be used.

### <S103>

In S103, the distribution unit 160 in the information distribution device 100 acquires a model from the model DB 130, and distributes (transmits) the model to the terminal 200. The timing of the distribution may be periodic, may be a timing at which a distribution request is received from the terminal 200, may be any timing when communication with the terminal 200 is possible, or may be any other timing.

The model to be distributed may be a model trained by machine learning, may be a propagation estimation result, or may be both of these. The reception unit 260 in the terminal 200 receives the model distributed from the distribution unit 160. The model is stored in the model DB 270. The prediction unit 280 reads out the model from the model DB 270 and holds it.

### <S104>

In S104, the prediction unit 280 of the terminal 200 executes a prediction of communication quality using the model. The control determination unit 290 is notified of the predicted value.

As an example, the input information generation unit 250 predicts a future position of the terminal 200 on the basis of the position information acquired by the position acquisition unit 220, and inputs the information on the future position to the prediction unit 280. The prediction unit 280 uses the model to acquire a predicted value of the communication quality at the future position.

For example, in a case where the model used is a trained machine learning model, a predicted value of throughput is acquired as an example of communication quality. Furthermore, in a case where the model used is the propagation estimation result, a predicted value of the received power is acquired as an example of the communication quality. In a case where a predicted value of the received power is acquired, the throughput may be estimated from the received power.

The prediction processing by the prediction unit 280 may be executed in response to an inquiry from the control determination unit 290, or at other timings (for example, a timing at which an updated model is received).

### <S105>

In S105, the control determination unit 290 executes a control determination, and the control unit 300 performs control. For example, when the control determination unit 290 ascertains that the quality of the current line will deteriorate based on the predicted value, it determines that line switching is necessary and instructs the control unit 300 to switch the line. The control unit 300 executes control for switching the line used by the terminal 200.

The control determination unit 290 may be provided in a server or the like external to the terminal 200. In this case, information is exchanged between the control determination unit 290 and the prediction unit 280/control unit 300 via a network.

### <S106>

When the prediction unit 280 of the terminal 200 predicts communication quality using a model, a log is stored in the log DB 310. Furthermore, the position acquisition unit 220 and the communication quality acquisition unit 210 continuously acquire the position and communication quality.

The position and communication quality are also stored as logs in the log DB 310.

For example, after the prediction operation in the terminal 200 is completed, the information notification unit 240 reads out the log from the log DB 310 and transmits the log to the information distribution device 100 as feedback. The information distribution device 100 can use the log to re-learn the model.

For example, it is assumed that the log includes a predicted value of communication quality obtained by using a model from a predicted future position and an actual measurement result at the position. By using this information, the learning unit 120 in the information distribution unit device 100 can re-learn the model to predict communication quality more accurately.

The above-mentioned steps S103 to S106 are repeated. Steps S101 to S106 may be repeated.

### Second Example

Next, a second example will be described. The models that are the targets of ensemble learning and the like in the second example are models that are trained by machine learning.

In the second example, a learning unit 320 is also disposed in the terminal 200. By disposing the learning unit 320, it becomes possible for the terminal 200 to measure communication quality/position constantly or at any timing, and can also learn a model.

For example, a notification of a model created by the terminal 200 (each of a plurality of terminals may be used) is provided to the information distribution device 100 periodically or at any timing. The information distribution device 100, for example, generates one model through ensemble learning using a plurality of models received from a plurality of terminals 200, thereby improving the prediction accuracy of the model.

### Second Example: Example of Device Configuration

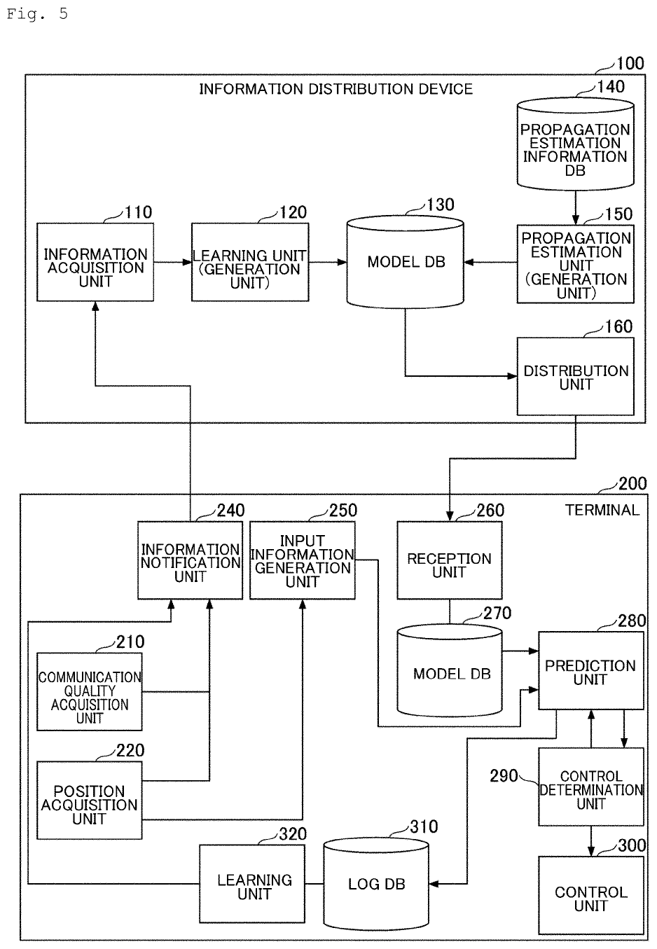

FIG. 5 illustrates an example of the configuration of the information distribution device 100 and the terminal 200 according to the second example. The configuration of the information distribution device 100 is the same as that in the first example (FIG. 3). The configuration of the terminal 200 is the same as that of the first example (FIG. 3) except that a learning unit 320 is added.

### First Example: Operational Example

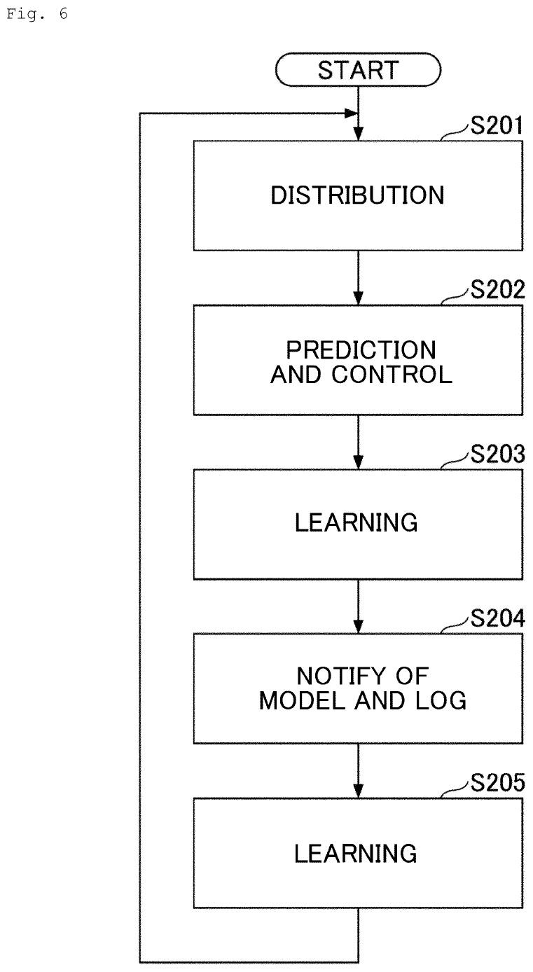

An operational example of each device having the configuration illustrated in FIG. 5 will be described with reference to the flowchart of FIG. 6. The configuration in the second example can also perform the operations described in the first example, but here the operation of performing ensemble learning using a plurality of models acquired from a plurality of terminals will be described. In addition, the information distribution device 100 may perform ensemble learning using a model (the model described in the first example) generated (learned) from position information and communication quality data received from one or more terminals, and a plurality of models received from a plurality of terminals, as described below.

### <S201>

In S201, the distribution unit 160 in the information distribution device 100 acquires a model from the model DB 130, and distributes (transmits) the model to the terminal 200. The timing of the distribution may be periodic, may be a timing at which a distribution request is received from the terminal 200, may be any timing when communication with the terminal 200 is possible, or may be any other timing.

The reception unit 260 in the terminal 200 receives the model distributed from the distribution unit 160. The model is stored in the model DB 270. The prediction unit 280 reads out the model from the model DB 270 and holds it.

### <S202>

In S202, the prediction unit 280 of the terminal 200 executes a prediction of communication quality using the model. The control determination unit 290 is notified of the predicted value. As an example, the input information generation unit 250 predicts a future position of the terminal 200 on the basis of the position information acquired from the position acquisition unit 220, and inputs the information on the future position to the prediction unit 280. The prediction unit 280 uses the model to acquire a predicted value of the communication quality at the future position. Similarly to the first example, control is performed on the basis of the predicted value.

When the prediction unit 280 of the terminal 200 predicts communication quality using a model, a log is stored in the log DB 310. Furthermore, the position acquisition unit 220 and the communication quality acquisition unit 210 continuously acquire the position and communication quality. These are also stored as logs in the log DB 310.

The log includes, for example, a predicted value of communication quality obtained by using a model from a predicted future position and an actual measurement result at the position. The log may include positions and measurement results without including a predicted value.

### <S203>

When a predetermined number or more of logs are stored in the log DB 310, in S203, the learning unit 320 uses the logs to learn a model that outputs communication quality from a position.

### <S204>

In S204, the information notification unit 240 notifies the information distribution device 100 of the model learned by the learning unit 320 and the log read out from the log DB 310 periodically or at any timing.

The information acquisition unit 110 in the information distribution device 100 acquires the model and log provided by the terminal 200, and holds them in a storage unit such as a memory.

### <S205>

In S205, the learning unit 120 of the information distribution device 100 performs ensemble learning using the plurality of models and the plurality of logs received from the plurality of terminals 200, thereby generating one model from the plurality of models. The generated model is stored in the model DB 130. The processes of S201 to S205 are repeatedly executed.

### Example of Hardware Configuration

Both the information distribution device 100 and the terminal 200 described in the present embodiment can be implemented, for example, by causing a computer to execute a program. This computer may be a physical computer, or may be a virtual machine on a cloud. Hereinafter, the information distribution device 100 and the terminal 200 will be collectively referred to as “devices.”

Specifically, the device can be implemented by executing a program corresponding to the processing to be performed in the device, using hardware resources such as a CPU and a memory built into the computer. The program can be stored and distributed by being recorded in a computer-readable recording medium (portable memory or the like). Furthermore, the program can also be provided through a network such as the Internet or an electronic mail.

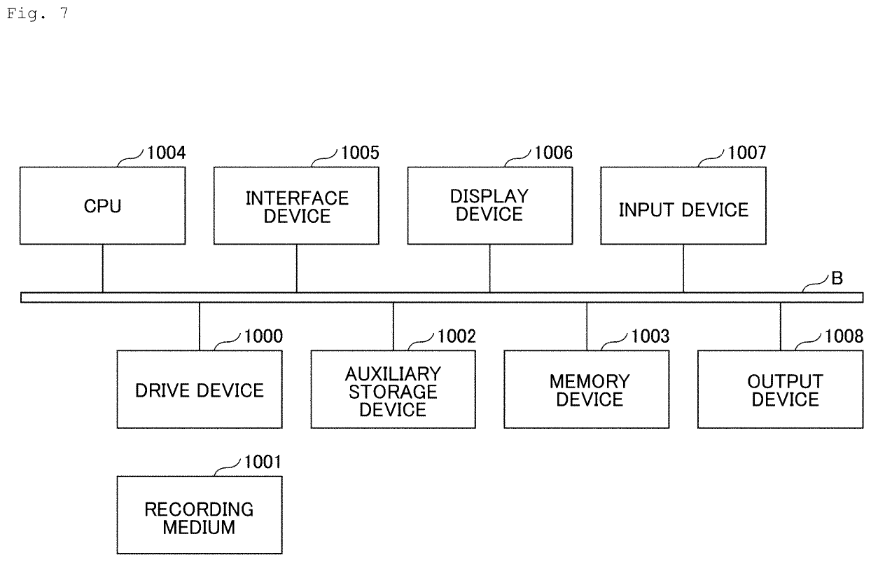

FIG. 7 is a diagram illustrating an example of a hardware configuration of the computer. The computer illustrated in FIG. 7 includes a drive device 1000, an auxiliary storage device 1002, a memory device 1003, a CPU 1004, an interface device 1005, a display device 1006, an input device 1007, an output device 1008, and the like, which are connected to each other via a bus BS. The computer may further include a GPU.

The program for implementing the processing in the computer is provided by, for example, a recording medium 1001 such as a CD-ROM or a memory card. When the recording medium 1001 in which the program is stored is set in the drive device 1000, the program is installed from the recording medium 1001 to the auxiliary storage device 1002 through the drive device 1000. However, the program need not necessarily be installed from the recording medium 1001, and may be downloaded from another computer via a network. The auxiliary storage device 1002 stores the installed program and stores necessary files, data, and the like.

When an activation instruction for the program is given, the memory device 1003 reads out the program from the auxiliary storage device 1002 and stores the program. The CPU 1004 implements a function related to the device in accordance with a program stored in the memory device 1003. The interface device 1005 is used as an interface for connection to a network or the like. The display device 1006 displays a graphical user interface (GUI) or the like based on a program. The input device 1007 includes a keyboard and mouse, buttons, a touch panel, or the like, and is used to input various operation instructions. The output device 1008 outputs a calculation result.

### Effects of Embodiment

According to the technology described in the present embodiment, it is possible to calculate a predicted value in a terminal without acquiring the predicted value from a server equipped with a model for predicting communication quality.

Accordingly, even if communication between the terminal and the server is interrupted, the communication quality can be predicted within the terminal, and terminal control can be continued using the predicted value.

Furthermore, by distributing the model from the information distribution device to the terminal periodically or at any timing, it is possible to use predicted values using the model that is updated each time. In addition, by enabling machine learning training within the terminal, it becomes possible to generate more accurate models using models generated from a plurality of terminals.

Regarding the above embodiments, the following clauses are further disclosed.

### Clause

### (Clause 1)

An information distribution device including:
a memory; and
at least one processor connected to the memory, in which the processor is configured to:
generate a model for predicting communication quality in a terminal; and
distribute the model to the terminal.
   (clause 2)

The information distribution device according to clause 1, in which the processor is configured to:
receive data including position information and communication quality from one or more terminals; and
use the data to learn the model.
   (clause 3)

The information distribution device according to clause 1 or 2, in which the processor is configured to use a plurality of models received from a plurality of terminals to learn the model.

(clause 4)

The information distribution device according to any one of clauses 1 to 3,
in which the processor is configured to:
acquire a propagation estimation result by performing propagation estimation in a target area; and
distribute the propagation estimation result to the terminal as the model.
   (clause 5)

A prediction system including the information distribution device according to any one of clauses 1 to 4 and the terminal,
in which the terminal includes a prediction unit configured to calculate a predicted value of communication quality using the model.
   (clause 6)

An information distribution method executed by an information distribution device, the information distribution method including:
a step of generating a model for predicting communication quality in a terminal; and
a step of distributing the model to the terminal.
   (clause 7)

A non-transitory storage medium storing a program for causing a computer to function as each unit in the information distribution device according to any one of clauses 1 to 4.

Although the present embodiment has been described above, the present invention is not limited to such a specific embodiment, and various modifications and changes can be made within the scope of the gist of the present invention described in the claims.

### REFERENCE SIGNS LIST

100 Information distribution device
110 Information acquisition unit
120 Learning unit
130 Model DB
140 Propagation estimation information DB
150 Propagation estimation unit
160 Distribution unit
200 Terminal
210 Communication quality acquisition unit
220 Position acquisition unit
240 Information notification unit
250 Input information generation unit
260 Reception unit
270 Model DB
280 Prediction unit
290 Control determination unit
300 Control unit
310 Log DB
320 Learning unit
1000 Drive device
1001 Recording medium
1002 Auxiliary storage device
1003 Memory device
1004 CPU
1005 Interface device
1006 Display device
1007 Input device
1008 Output device

1. An information distribution apparatus comprising:
circuitry configured to:
generate a first model that predicts communication quality at each terminal of one or more terminals; and distribute the first model to each terminal.

2. The information distribution apparatus according to claim 1, wherein the circuitry is further configured to receive data including (i) position information and (ii) the communication quality, from each terminal of the one or more terminals, to learn the first model using the data.

3. The information distribution apparatus according to claim 1, wherein the circuitry is further configured to receive plurality of second models from the respective terminals, to learn the first model using the plurality of second models.

4. The information distribution apparatus according to claim 1, wherein the circuitry is configured to:
acquire a propagation estimation result by performing propagation estimation in a target area; and distribute the propagation estimation result to the one or more terminals as the first model.

5. A prediction system comprising:
the information distribution apparatus according to claim 1; and
the one or more terminals each of which includes circuitry configured to calculate a predicted value of the communication quality, using the first model.

6. An information distribution method executed by an information distribution apparatus, the information distribution method comprising:
generating a model that predicts communication quality at one or more terminals; and
distributing the model to each terminal of the one or more terminals.

7. A non-transitory computer readable storage medium storing a program configured for causing a computer to execute the information distribution method of claim 6.
